(19) United States
(12) Patent Application Publication
(10) Pub. No.: US 2026/0220503 A1
(43) Pub. Date: Jul. 30, 2026

(54) SYSTEMS AND METHODS FOR GENERATING PERSONALIZED CONTENT

(71) Applicant: Walmart Apollo, LLC, Bentonville, AR (US)

(72) Inventors: Shreyas Saiprasad Jadhav, San Francisco, CA (US); Ali Arsalan Yaqoob, Union City, CA (US); Shengwei Tang, San Jose, CA (US); Shuling He, San Jose, CA (US); Priyank Gupta, Duvall, WA (US); Pratik Saha, Dublin, CA (US); Hyun Duk Cho, San Francisco, CA (US); Selene Xu, San Francisco, CA (US); Praveenkumar Kanumala, Newark, CA (US); Malay Kumar Patel, Fremont, CA (US); Sushant Kumar, San Jose, CA (US); Kannan Achan, Saratoga, CA (US)

(21) Appl. No.: 19/041,791

(22) Filed: Jan. 30, 2025

(51) Int. Cl. G06N 5/04

(52) U.S. Cl. CPC G06N 5/04

(57) ABSTRACT

In some embodiments, apparatuses and methods are provided herein useful to generate personalized content. In some embodiments, a system comprising a processing resource; a machine readable medium storing instructions that, when executed, cause the processing resource to: aggregate, session data during a client session; update, periodically and during the interaction session, one or more inference indicators associated with the client in an inference cache storage, the one or more inference indicators being determined via a trained machine learning model using the session data and historical data in a historical data database; identify a trigger event based on client interactions; retrieve, in response to the trigger event, at least one inference indicator associated with the client from the inference cache storage; and generate a personalized content for display on the client device based on the at least one inference indicator retrieved from the inference cache storage.

### TECHNICAL FIELD

This disclosure relates generally to network communication management and, more particularly, to managing latency in generating content for display on a client device.

### BACKGROUND

Interactive content provided over a network, such as websites and mobile applications, is increasingly being personalized and customized to enhance the client-side experience. However, the computational demands of the complex processing required to deliver such content can introduce latencies in the system. Specifically, as complex algorithms generally require more time to execute, there is often a trade-off between the immediacy of the personalization and the complexity of the data processing involved, including the volume of data that must be processed to generate personalized content.

### BRIEF DESCRIPTION OF DRAWINGS

Disclosed herein are embodiments of systems, apparatuses and methods involving generating personalized content. This description includes drawings, wherein:

FIG. 1 is a block diagram depicting an example system for generating personalized content in accordance with some embodiments.

FIG. 2 is a block diagram depicting a machine readable medium with example instructions for generating personalized content in accordance with some embodiments.

FIG. 3 is a flow diagram depicting an example method for generating personalized content in accordance with some embodiments.

FIG. 4 is a block diagram of an example feature extractor implemented through a processing resource executing the instructions, in accordance with some embodiments.

FIG. 5 is a block diagram of an example model inferencing platform implemented through the processing resource executing the instructions, in accordance with some embodiments.

FIG. 6 is a block diagram of an example system for generating personalized content in accordance with some embodiments.

FIG. 7 is an example system that includes one or more non-transitory, machine readable media encoded with example instructions executable by one or more processing resources, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to generate content to provide a personalized client interaction. The embodiments may allow a client, such as a customer, to be presented with items (e.g., products and services) that are more relevant to (e.g., likely to interest) the client based on historical data and current session date. For example, the embodiments may allow for real time inferencing of machine learning models to generate personalized content, adapted to changing client preferences at various stages of the client’s interactions which minimize friction (e.g., irrelevant content, slow response times) and enhance client interaction.

The present embodiments address known issues in creating a personalized user interface interaction experience due to client dynamic preferences and behavior patterns in response to general trend shifts and personal changes over time, clients shifting exploration journeys on a website, and little historical data for new and reactivated clients. Some present embodiments in part utilize processing resources to asynchronously process relevant current client session and a previous client session information to improve content displayed. The content display may be based in part on more accurate predictions of a client’s intent, such as, for example, a client’s commitment to purchase, a shopping session completeness, or a client exploration interest. The processing resource performs feature generation and model inferencing in an asynchronous fashion to provide more accurate predictions through complex operations since it is not limited to real time latency requirements from a downstream application. The processing resources further address these latency problems in part by caching the latest model inference prediction, also referred to as inference indicators, in an online cache for a downstream application to consume.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

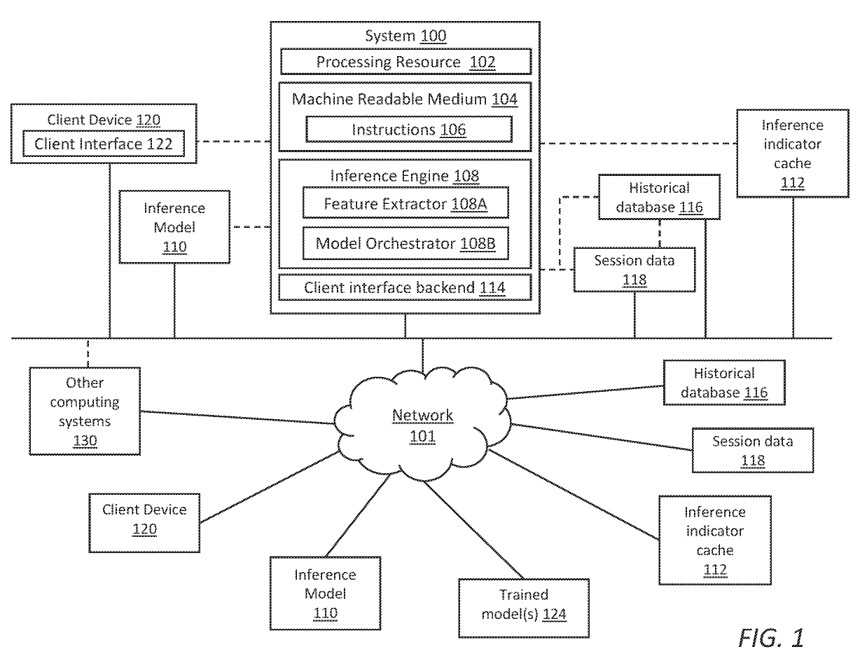

Referring now to the figures, FIG. 1 depicts an example system 100 for generating personalized content. The system 100 may include a processing resources 102 and a client interface backend 114 communicatively coupled over a network 101 to a client device 120. The processing resource 102, client interface backend 114, and client device 120 can be any suitable computing device that includes any hardware or hardware and software combination for processing and handling information. In addition, each may transmit and receive data over the network 101.

The processing resource 102 may include a microcontroller, a microprocessor, central processing unit core(s), an application-specific integrated circuit (ASIC), a field programmable gate array (FPGA), etc. The system 100 includes machine readable medium 104 that may be non-transitory and include random access memory (RAM), read-only memory (ROM), electrically erasable programmable read-only memory (EEPROM), flash memory, a hard disk drive, etc. The processing resource 102 may execute instructions 106 (i.e., programming or software code) stored on machine readable medium 104 to perform functions of the system 100. Additionally, or alternatively, the processing resource 102 may include electronic circuitry for performing the instructions and functionality described herein. In that regard, the processing resource 102 may be configured to execute and perform certain operations. In this context, the term processing resource 102 refers broadly to any microcontroller, computer, or processor-based device with processor, memory, and programmable input/output peripherals.

The one or more networks 101 can be substantially any relevant wired and/or wireless computer and/or communications networks (one or more local area networks (LAN), one or more wireless area networks (WAN), one or more other wireless networks (e.g., cellular, Wi-Fi, Bluetooth, LoRa, LoRa-WAN, etc.), other such networks, or a combination of two or more of such networks). While one processing resource 102 is shown, in some forms, the functionalities of the processing resource 102 may be implemented on one or more computing systems 130 communicating on the network 101.

In some examples, the processing resource 102 can be a computer, a workstation, a laptop, a server such as a cloud-based server, or any other suitable device. In some examples, the processing resource 102 is a server that includes one or more processing units, such as one or more graphical processing units (GPUs), one or more central processing units (CPUs), and/or one or more processing cores. The processing resource 102 may, in some examples, execute one or more virtual machines. In some examples, processing resources (e.g., capabilities) of the processing resource 102 are offered as a cloud-based service (e.g., cloud computing). For example, network 101 (e.g., cloud-based network) may offer computing and storage resources of the processing resource 102. In some examples, one or more computing systems 130 are used to offer computing and storage resources of the processing resource 102.

The client device 120 is any type of electronic communication device. For example, the client device 120 may include a cellular phone, a smart phone, a tablet, a personal assistant device, a voice assistant device, a digital assistant, a laptop, a computer, or any other suitable device. The client device 120 may include a client interface 122 to allow client interaction with the client device 120. For example, client interface 122 can be a client interface for an application of a retailer that allows a client to view and interact with a retailer's website. In some examples, a client can interact with client interface 122 by engaging input-output devices of the client device 120. In some examples, the client device 120 may include a touchscreen display, where client interface 122 is displayed on the touchscreen. In some examples, the processing resource 102 and the client interface backend 114 are operated by a retailer, and the client device 120 are operated by clients of the retailer. In some examples, processing resource 102 or client interface backend 114 are operated by a third party (e.g., a cloud-computing provider).

The client interface backend 114 may include suitable electronic infrastructure to host, by a web server, a website, such as a retail website. For example, the client interface backend 114 may include servers, databases, application servers, and application programming interfaces (APIs) that manage the website’s functionality.The client interface backend 114 allows the client to browse items, make purchases, and interact with the website. For example, the client may, via a web browser, view item recommendations for items displayed on the website hosted by the client interface backend 114, and may click on item recommendations, for example. The website may capture these activities as client session data 118, and the client interface backend 114 may transmit the client session data 118 to processing resource 102 over network 101. The website may also allow the client to add one or more of the items to an online shopping cart, and allow the client to perform a “checkout” of the shopping cart to purchase the items. In some examples, the client interface backend 114 transmits purchase data identifying items the client has purchased from the website to the processing resource 102. The session data 118 may include information generated based on a client interaction, during an interaction session, in the client interface 122 of the client device 120. Such session data can, for example, include items viewed, items added to a virtual cart, quantities of items in the virtual cart, item prices, item fulfillment types, search queries, an average time between actions, and/or an average time between changes in the virtual cart.

In some examples, the processing resource 102 may execute one or more models (e.g., algorithms), such as a machine learning model, statistical model, etc., to determine personalized content to present to the client (e.g., item recommendations or item promotions). For example, the machine learning models may include inference model 110 and/or other trained models 124. Processing resource 102 may transmit the one or more inference indicators to client interface backend 114 over network 101, and client interface backend 114 may display recommendations for one or more of the recommended items on the website accessed by the client device 120 and displayed on the client interface 122. For example, client interface backend 114 may display the item recommendation to the customer on a homepage, a catalog webpage, an item webpage, or a search results webpage of the website (e.g., as the customer browses those respective webpages).

The system 100 may further include an inference engine 108. More specifically, the inference engine 108 may include a feature extractor 108A, a model orchestrator 108B. The operation and interaction of the inference engine 108 are described further below. In some examples, the inference engine 108 may be implemented in hardware. In some examples, the inference engine 108 may be an executable program or software code stored on machine readable medium 104 that when executed by the processing resource 102 causes the processing resource 102 to perform functions of the inference engine 108. The inference engine 108 may be part of the system 100 or may be separate from the system 100 and may be accessible and communicatively coupled to the processing resources 102 and the client interface backend 114 via the network 101.

In some examples, the machine readable medium 104 stores instructions 106 that, when executed by the processing resource 102, cause the processing resource to initiate the inference engine 108 to determine and/or periodically update one or more inference indicators. The historical database 116 and the session data 118 are used as an input to the inference model 110 to determine and/or update the one or more inference indicators. For example, the inference indicators may include a measure of how likely the client is to check out in the short future, where the client is in there basket building process, and/or a measure of a level of interest of a customer in exploring products outside of their main shopping task. The regularly refreshed (e.g., periodically updated) inference indicators may be cached in the inference cache 112 so that when downstream applications request the inference indicators, they simply look up the online inference cache 112 to generate and display personalized content on client interface 122 of the client device 120.

The processing resource 102 may be communicatively coupled to historical database 116. For example, the processing resource 102 can store data to, and read data from, historical database 116. The historical database 116 can be a remote storage device, such as a cloud-based server, a disk (e.g., a hard disk), a memory device on another application server, a networked computer, or any other suitable remote storage. Although shown remote to processing resource 102, in some examples, historical database 116 can be a local storage device, such as a hard drive, a non-volatile memory, or a USB stick. In some example, the historical database 116 can store historical data that includes information generated based on a previous client interaction, during a previous interaction session, in the client interface 122 of the client device 120. Such historical data can, for example, include item view history, purchase history, search history, and/or cart history from one or more prior interaction sessions.

In some examples, processing resource 102 receives current session data 118 from client interface backend 114. The session data 118 may identify actions (e.g., executed activity) of the client on a website. For example, the client session data 118 may identify item impressions, item clicks, items added to an online shopping cart, conversions, click-through rates, advertisements viewed, and/or advertisements clicked during an ongoing browsing session (e.g., the user data identifies real-time events). The inference engine 108 may generate inference indicators based on the user session data and historical user data (e.g., historical user transaction data, historical user engagement data). For example, processing resource 102 may determine one or more perceived client intents for the current client session based on an ordered list of items the client interacted (e.g., engaged) with in real-time.

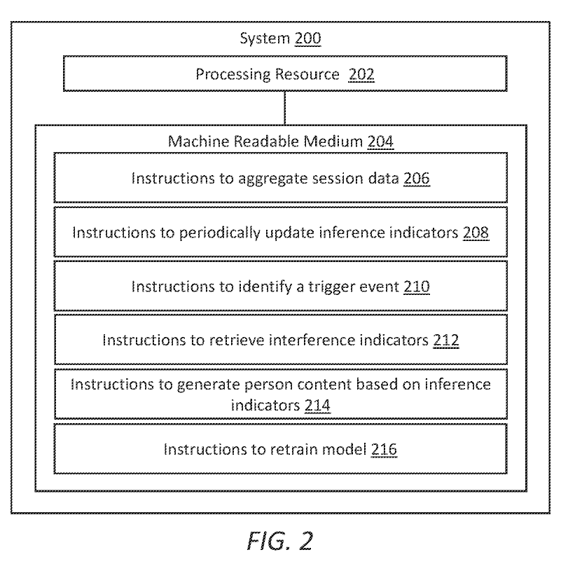

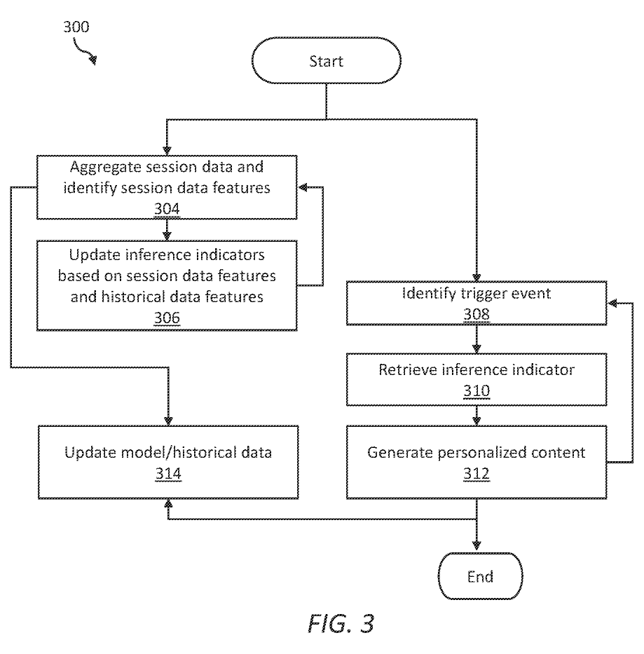

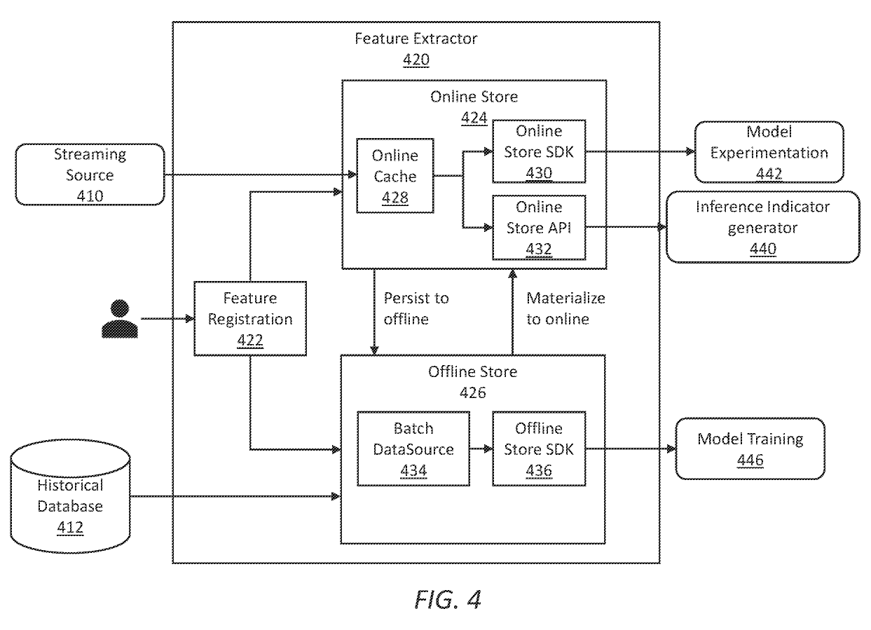

FIG. 2 depicts example system 200 that includes one or more non-transitory, machine readable medium 204 encoded with example instructions executable by one or more processing resources 202, in accordance with some embodiments. In some embodiments, the system 200 may be useful for implementing aspects of the system 100 and/or in performing some or all aspects of the process of FIG. 3. For example, the instructions encoded on machine readable medium 204 may be included in instructions 106 of FIG. 1. In some implementations, functionality described with respect to FIGS. 4-6 may be included in the instructions encoded on machine readable medium 204.

The one or more processing resources 202 may include a microcontroller, a microprocessor, central processing unit core(s), an ASIC, an FPGA, and/or other hardware device suitable for retrieval and/or execution of instructions from the machine readable media 204 to perform functions related to various examples. Additionally or alternatively, the processing resources 202 may include or be coupled to electronic circuitry or dedicated logic for performing some or all of the functionality of the instructions described herein.

The machine readable medium 204 may be any medium suitable for storing executable instructions, such as RAM, ROM, EEPROM, flash memory, a hard disk drive, an optical disc, or the like. In some example implementations, the machine readable medium 204 may be a tangible, non-transitory medium. The machine readable medium 204 may be disposed within the system 200, in which case the executable instructions may be deemed installed or embedded on the system. Additionally or alternatively, some or all of the machine readable medium 204 may be one or more remote, external to and/or portable storage medium, and may be part of an installation package.

As described further herein, the machine readable media 204 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 2.

With reference to FIG. 2, the machine readable medium 204 includes instructions 206, 208, 210, 212, 214, 216. Further, in some embodiments, the instructions 206, 208, 210, 212, 214, 216 are executed during a client interaction in a client interface 122 provided to a client device 120.

Instructions 206, when executed, cause the processing resource 202 to aggregate session data based on the client interaction in the client interface provided to the client device during an interaction session. The session data may include interactions (e.g., actions executed) during a current session by the client on the client interface of the client device. In some forms, the session data may include items viewed, items added to a virtual cart, quantities of items in the virtual cart, item prices, item fulfillment types, search queries, an average time between actions, and/or an average time between changes in the virtual cart.

Instructions 208, when executed, cause the processing resource 202 to update one or more inference indicators associated with the client in an inference cache storage. The one or more inference indicators may be determined via a trained machine learning model using the session data and historical data in a historical database. In one form, the one or more inference indicators are periodically updated and redetermined by the one or more processing resources 202 every one to ten minutes while the interaction session is active.

Instructions 210, when executed, cause the processing resource 202 to identify a trigger event based on client interactions in the client interaction session and subsequent to the one or more inference indicators being updated. Such trigger actions can, for example, include an item being added to a virtual cart, a number of items in a virtual cart, an initiated search for a product, based on keywords and/or other such search, an activation to display particular data (e.g., a webpage corresponding to a product selected by a user), other such triggers or a combination of two or more of such triggers.

Instructions 212, when executed, cause the processing resource 202 to retrieve at least one inference indicator associated with the client from the inference cache storage. Such inference indicators can, for example, include a cross-category purchase probability, a measure of a user commitment to purchase, a shopping session completeness, or a user exploration interest, a likelihood of a fulfillment method, the fulfillment method being one of in-store pickup, delivery, or shipping.

Instructions 214, when executed, cause the processing resource 202 to generate personalized content for display on the client device based on the at least on inference indicator retrieved from the inference cache storage. Such personalized content can, for example, include one or more items and/or one or more promotions selected for display based on the inference indicator.

Instructions 216, when executed, cause the processing resource 202 to retrain the trained machine learning model using the session data. In some examples, the instructions 216, when executed, cause the processing resource 202 to record subsequent interactions with the personalized content as part of the session data and use the session data, including the subsequent interactions, to retrain the trained machine learning model.

FIG. 3 illustrates a flow diagram of an example process 300 for generating personalized content to a client. The process 300, in some embodiments, is implemented during a current session between a client and a client interface backend 114 based on communications between a client device 120 and the client interface backend 114. In step 304, the processing resource 202, executing instructions stored on the machine readable medium 204, aggregates session data based on client interactions (e.g., executed actions) in a client interface provided to a client device. In step 306, the processing resource 202, executing instructions stored on the machine readable medium 204, periodically updates during the interaction session, one or more inference indicators associated with the client in an inference cache storage. The one or more inference indicators are determined and updated by a trained machine learning model based on session data and historical data stored in a database. In some embodiments, a streaming technology (e.g., Apache Spark streaming technology) may be used to process raw session data and perform feature engineering to identify session features and historical features. The session features and historical features become input features to the inference model to determine the one or more inference indicators. In step 308, the processing resource 202, executing instructions stored on the machine readable medium 204, identifies a trigger event based on client interactions in the client interface during the interaction session and subsequent to the one or more inference indicators being updated. In response to the trigger event, in step 310, the processing resource 202, executing instructions stored on the machine readable medium 204, retrieves at least one inference indicator associated with the client from the inference cache storage. In step 312, the processing resource 202, executing instructions stored on the machine readable medium 204, generates a personalized content for display on the client device based on the at least one inference indicator retrieved from the inference cache storage. In step 314, the processing resource 202, executing instructions stored on the machine readable medium 204, updates the inference model and stores the session data in the historical database to be used for future client interactions. For example, the processing resource 202, executing instructions stored on the machine readable medium 204, records subsequent interactions with the personalized content as part of the session data and uses the session data, including the subsequent interactions, to retrain the trained machine learning model.

FIG. 4 illustrates a block diagram of an example feature extractor 420, implemented through the processing resource 102 executing the instructions 106, in accordance with some embodiments. The feature extractor 420 receives session data (e.g., in-session signals) from a streaming source 410, and accesses a historical database 412 to receive historical data to apply feature processing to the combination of information. The processed features may be used as an input to an inferencing model to generate one or more interference indicators. The session data can be obtained and/or aggregated during a current session based on client interactions (e.g., actions executed) in the current session by the client in the client interface 122 on the client device 120. Such client interactions can, for example, include items viewed, items added to a virtual cart, quantities of items in the virtual cart, item prices, item fulfillment types, search queries, an average time between actions, and/or an average time between changes in the virtual cart. In some examples, the client interaction can include subsequent client interactions with the personalized content generated from the inferencing model using the client interactions previously recorded during the same client session. The historical data stored in the historical database 430 may have been previously obtained during a previous session based on previous client interactions by the client in the client interface 122 on the client device 120. The historical data may include, for example, item view history, purchase history, search history, and/or cart history from one or more prior interaction sessions.

In some embodiments, the streaming source 410 may include streaming technology (e.g., Apache Spark streaming technology) to process raw session data and perform feature engineering to identify session features. This technology allows for more complex feature engineering operations such as time elapsed since the last add-to-cart action, ratio of item page view versus add-to-cart action and the like.

In some forms, the session data from the streaming source 410 and the historical data from the historical database 412 may be received as a stream of unstructured data. The feature extractor 420, in part, formats the session data and historical data into a structured format. For example, the feature extractor 420 may identify session features based on the session data and historical features based on the historical data. The session features and the historical features may be identified and extracted based on a set of registered features. The session features and historical features can be stored and/or cached in one or more mediums and/or partitions of mediums. For example, the session features can be maintained and updated in an online store 424 and the historical features can be maintained and updated in an offline store 426. It is noted that in previous systems that attempt to provide model inferencing, there is no need for the concept of feature storage because the generation of features and any inference are done on a single logic layer with features simply passed to an inference system on the same system logic layer.

The online store 424 may include an online cache 428, an online store software development kit (SDK) 430, and an online store application programming interface (API) 432. The online cache 428 may store and/or cache the session features to reduce latency and improve real-time performance. The online store software development kit (SDK) 430 may be communicatively coupled to a model experimentation resource 442 to use the session features stored and/or cached in the online cache 428 to facilitate development of a machine learning model (e.g., inference model 110) and feedback collection. The online store API 432 may be communicatively coupled to the inference indicator generator 440 to determine the one or more inference indicators via the machine learning model (e.g., the inference model 110).

The offline store 426 may include batch data source 434 and offline store software development kit (SDK) 436. The historical features may be stored in the batch data source 434.The offline store SDK 436 may be communicatively coupled to a model training resource 446 to use the historical features maintained the in batch data source 434 for machine learning model training and/or retraining over time to generate modified, updated machine learning models (e.g., inference models 110) expected to provide more accurate results.

In some embodiments, the feature data stored and/or cached in the online store 424 may persist to the offline store 426 for long-term storage and historical analysis. By persisting feature data to the offline store 426, the feature extractor 420 can maintain a comprehensive record of feature values over time to be used for model training, batch inference, and data exploration. In addition, feature data stored in the offline store 426 may materialize to the online store 424 to be used for real-time inference indication generation by the inference indicator generator 440.

In some embodiments, the feature extractor 420 may receive, process and store, during the current client interaction session, session data at a fixed cadence. In other words, the feature extractor 420 may repeatedly receive, process, and store the session data at each repetition of a predefined interval of time (e.g., 1-minute) and execute asynchronous feature processing according to the one or more predefined intervals to provide feature updates at repeated periodic timeframes allowing more time for feature processing. This provides a process of data collection and updates of session features at a periodic timeframe, whereas previous systems waited for requests from downstream applications to start feature processing which significantly reduces capabilities because of the limited time available to provide effective responses. In other words, the feature extractor 420 is not limited to real time latency requirements from downstream applications. It is contemplated that while the predefined interval in this example may be 1-minute, other such intervals may be used.

In some embodiments, the feature extractor 420 include a feature registration 422. The feature registration monitors and/or ensures that the features in the online store 424 and the offline store 426 are consistent.

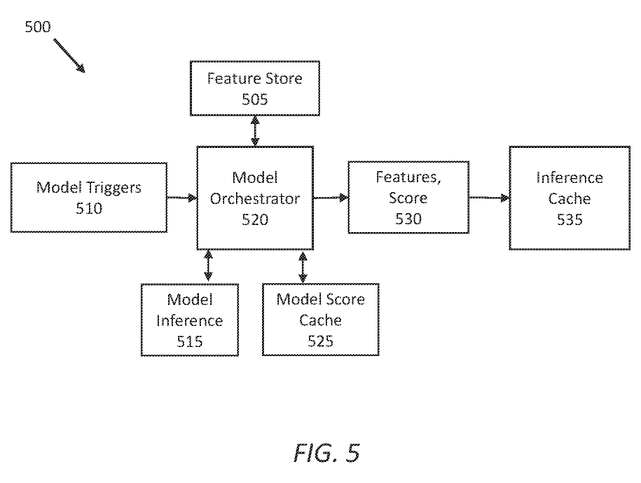

FIG. 5 illustrates a block diagram of an example model inferencing platform 500 implemented through the processing resource 102 executing the instructions 106, in accordance with some embodiments. The processing resource 102 when executing the instructions 106 can trigger 510 a refresh query to the model inference 515 in response to a pre-defined trigger (e.g., an action trigger) initiated from a client interaction in a client interface 122 provided to a client device 120. Such actions can, for example, include trigger actions such as an item being added to a virtual cart, a number of items in a virtual cart, an initiated search for a product, based on keywords and/or other such search, an activation to display particular data (e.g., a webpage corresponding to a product selected by a user), other such triggers or a combination of two or more of such triggers.

The model inferencing platform 500 can include and/or activate a model orchestrator 520 or other functional control to receive the trigger 510 and coordinate the execution of the model inference 515 in response to the trigger 510. As compared to previous systems where the feature generation and model inferencing is triggered by a request from a downstream application, the model orchestrator 520 coordinates when to refresh model inferencing. If the model inference 515 is refreshed too frequently, a large computation cost may be incurred. Alternatively, if the model inference 515 is not refreshed frequently enough, the inference indicators will not be updated fast enough yielding inaccurate results. As such, the model orchestrator 520 may coordinate the initiation and refresh of the model inference 515 based in part on the trigger 510 in response to the pre-defined trigger action. In some embodiments, the model orchestrator 520 may coordinate the initiation and refresh of the model inference 515 based in part on a current state or condition of the feature extractor 420. For example, the model orchestrator 520 may look at the trigger actions and a change to the in-session features of the client interaction during the interaction to determine when to refresh the model inference 515.

The model orchestrator 520 may access the feature store 505 to retrieve the session features and historical features as an input for the model inference 515. The model inference 515 may determine the one or more inference indicators 530 using the session features and the historical features as the input. Subsequent to the model inference 515 determining the one or more inference indicators, the model orchestrator 520 may coordinate the generation of one or more confidence scores associated with the inference indicators determined via the model inference 515. The model orchestrator 520 may log and/store the confidence scores in the model score cache 525. The processing resource 102 executing the instructions 106 may access the model score cache 525 to analyze the model inference 515 performance.

In addition, the model orchestrator 520 may coordinate the execution of the one or more inference indicators and one or more confidence scores provided by the model inference 515 to be stored in an inference cache 535 for a downstream application to consume. To that effect, internal and external requests for an inference indicator are directed to the inference cache 535 and the current inference indicators can be retrieved directly from the inference cache 535, without, in some embodiments, having to initiate the model inference 515. By storing the inference indicators and confidence scores in the inference cache 535, the inferencing platform 500 is capable of providing rapid in session responses to the client interactions of the client interface 122 on the client device 120 directly from the inference cache 535. In addition, the caching of the inference indicators may enable the model inference 515 to apply and/or deploy more complex machine learning models and/or additional models that could not be used in previous systems. For example, the model inference 515 may include a feedforward neural network model, a logistic regression model, and/or a multi-layer perceptron model. It is noted that in previous systems that attempt to provide inferencing, there is no need for the concept of inference indicator storage where a given downstream application will make a request to the platform for the generation of the inference information and receive the inference information back in the same call.

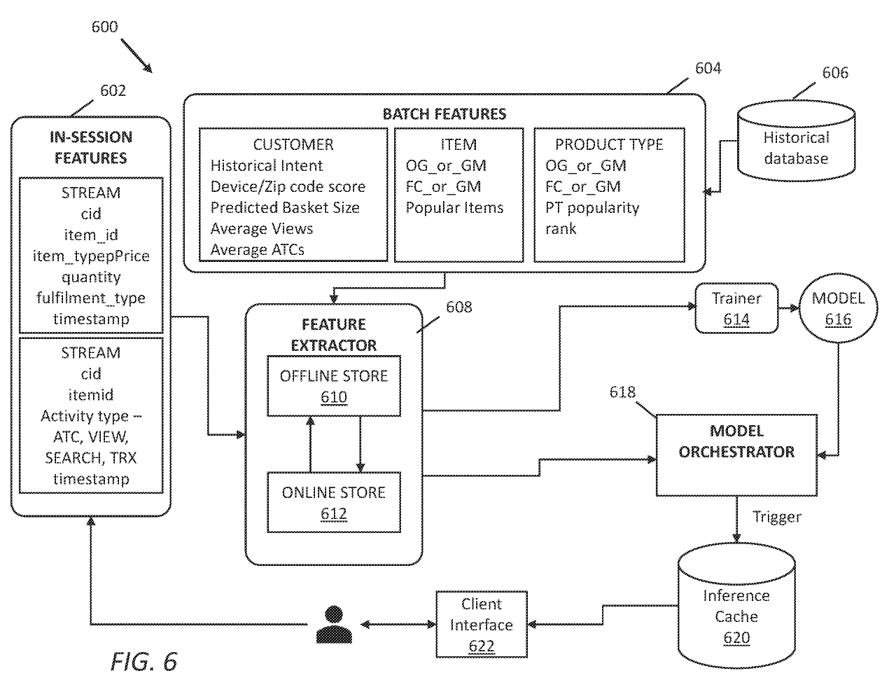

FIG. 6 illustrates a block diagram of an example system 600 for generating personalized content for display on the client device 120, implemented through the processing resource 102 executing the instructions 106, in accordance with some embodiments. The processing resource 102, when executing the instructions 106 stored on the machine readable medium 104, during an interaction session between a client interaction in a client interface provided to a client device 120 via a client interface backend 114, may obtain and/or aggregate session data based on the client interactions. The feature extractor 608 may receive the session data to generate (e.g., identify and extract) one or more in-session features 602. Other suitable features may be included. Below are examples of one or more of the in-session features 602 that may be generated from the session data:

cid: Client identifier identifying the client (e.g., a 4 number code);

item_id: Item identifier identifying the item (e.g., an SKU number);

item_typepPrice: Type of item and an item price identifying a description of an item purchased or stored in a virtual cart (e.g., a category or a product feature such as ingredients, benefits, use or consumption instructions, etc.) and an associated price of the item (e.g., dollars or cost features such as sales, promotions, etc.);

quantity: Number of items identifying one or more items purchased or stored in a virtual cart (e.g., n pairs of socks);

fulfilment_type: Method of fulfilment identifying one or more fulfilment options for the item (e.g., delivery, in-store pickup, digital download);

In addition, the in-session features 602 that may be generated from the session data may include a type of action taken by the client during the client session. Other suitable features may be included. Below are a few examples of one or more of the in-session features 602 that may be generated from the session data:

Add to cart (ATC): Items added (or removed) from a virtual cart (e.g., in the last X minutes);

View: Items viewed (e.g., in the last X minutes);

Search: Items search and/or searches conducted (e.g., in the last X minutes);

The processing resource 102, when executing the instructions 106 stored on the machine readable medium 104, during an interaction session between a client interaction in a client interface 622 provided to a client device via a client interface backend 114, may obtain and/or aggregate historical data stored in a historical database 606 recorded and/or stored from a previous client session between one or more previous client interactions in the client interface 622 provided to the client device via the client interface backend 114. The feature extractor 608 may receive and/or access the historical data in the historical database 606 to generate (e.g., identify and extract) one or more batch features 604. The batch features 604 may include a customer identification, an item identification and/or a product type. Other suitable features may be included. Below are a few examples of the one or more batch features 604 that may be generated from the historical data:

Historical Intent: Historical intentions based on one or more previous interaction sessions;

Device/Zip code score: Geographic location based on one or more previous interaction sessions;

Predicted Basket Size: Purchase history based on one or more previous interaction sessions;

Average Views: Item view history based on one or more previous interaction sessions;

Average ATCs: Item cart history based on one or more previous interaction sessions;

OG_or_GM: Item features (e.g., OG (online grocery), GM (general merchandise)) history based on one or more previous interaction sessions;

FC_or_GM: Item features (e.g., FC (Food and consumable), GM (general merchandise)) based on one or more previous interaction sessions;

Popular Items: Items favorites among clients based on one or more previous interaction sessions;

OG_or_GM: Product types (e.g., OG (online grocery), GM (general merchandise)) history based on one or more previous interaction sessions;

FC_or_GM: Product types (e.g., FC (Food and consumable), GM (general merchandise)) based on one or more previous interaction sessions;

In some embodiments, the feature extractor 608 may generate (e.g., identify and extract) in-session features 602 and the batch features 604 based on a set of registered features. The set of registered features may include predefined data points determined based on an input for one or more machine learning models. In some embodiments, the feature extractor 608 can utilize a streaming technology (e.g., Apache Spark streaming technology) to process raw in-session data (e.g., signals) and perform feature engineering.

The generated in-session features 602 and batch features 604 can be stored and/or cached in one or more mediums and/or partitions of a medium. For example, the generated in-session features 602 and batch features 604 can be maintained and updated in an offline store 610 and an online store 612. In some embodiments, the features in the offline store 610 can be used by a trainer 614 for machine learning model training and/or retraining over time to generate updated, trained models 616. In some embodiments, the model orchestrator 618 may receive and/or access the features in the online store 612 to coordinate the initiation of the model 616.

The model orchestrator 618 may retrieve the session features 602 and batch features 604 as an input for the model 616 to determine the one or more inference indicators. In some embodiments, the model orchestrator 618 may coordinate the initiation of the model 616. For example, the model orchestrator 618 may determine, in part, when to trigger the model 616 based on a pre-defined trigger action (e.g. add-to-cart action, item page view action) extracted from the in-session features 602. In addition, the model orchestrator 618 may determine, in part, when to trigger the model 616 based on a change to one or more features processed by the feature extractor 608 to determine and periodically update the one or more inference features.

The model orchestrator 618 may coordinate the execution of the one or more inference indicators provided by the model 616 to be stored in an inference cache 620 and the periodic updates of the one or more inference indicators provided by the model 616 for a downstream application to consume. To that effect, internal and external requests for an inference indicator are directed to the inference cache 535 and the current inference indicators can be retrieved directly from the inference cache 535, without, in some embodiments, having to initiate the model 616. Accordingly, the processing resource 102, when executing the instructions 106 stored on the machine readable medium 104, during an interaction session, may access the one or more inference features stored in the inference cache 620 to generate personalized content for display on a client interface 622 provided on a client device.

The feature extractor 608 and the model 616 operate in an asynchronous fashion which can continuously be implemented, whereas other previous systems are activated in response to a request. In one example, while a client is browsing and shopping on a retail website (e.g., via the client interface 622), the feature extractor 608 may gather real time in-session features 602 from this client at a fixed cadence (e.g., every 1-minute) and the model orchestrator 618 may coordinate the initiation of the model 616 at the same fixed cadence (e.g., every 1 minute). The model orchestrator 618 may also coordinate the initiation of the model 616 based on changes in the client’s interaction, for example, shopping patterns. The in-session features 602 and batch features 604 are input to the model to predict the inference indicators. For example, the inference indicators may include a measure of how likely the client is to check out in the short future, where the client is in there basket building process, and/or a measure of a level of interest of a customer in exploring products outside of their main shopping task. The regularly refreshed inference indicators may be cached in the inference cache 620 so that when downstream applications request the inference indicators, they simply look up the online inference cache 620 to generate and display personalized content on client interface 622. The personalized contented can, for example, include one or more items and/or one or more promotions selected for display based on the inference indicator This results in greater accuracy in generating personalized content for display to the client while reducing latency.

In some embodiments, the model orchestrator 618 may determine, in part, when to trigger the model 616 based on a second trigger action in the client interface 622 displaying the personalized content. The model orchestrator 618 may coordinate and/or retrieve, in response to the second trigger action, at least one inference indicator stored in the inference cache 620. The model orchestrator 618 may coordinate the generation of a second personalized content for display in the client interface 622 based on the at least one inference indicator retrieved from the inference cache 620. As such, the personalized content displayed in the client interface 622 can continuously be updated to adapt to client preferences at various stages in the client interaction session to further improve the displayed content through a tailored interaction.

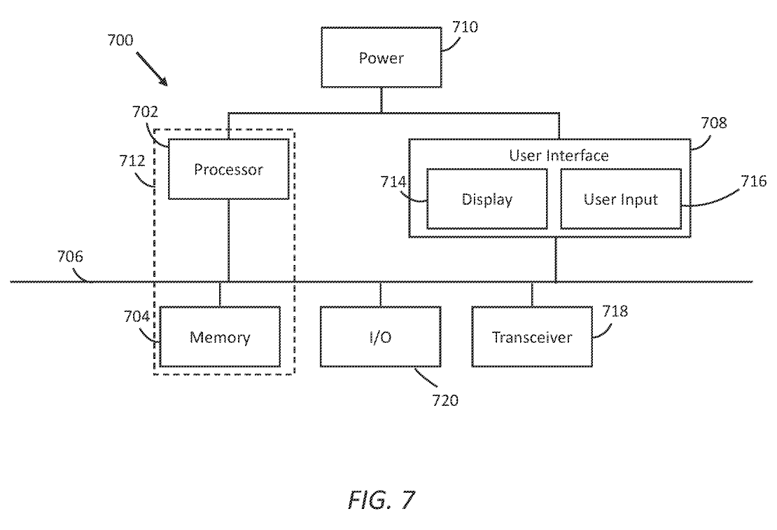

FIG. 7 illustrates an example system 700 that may be used for implementing any of the components, processing resources, circuits, circuitry, systems, functionality, logic, apparatuses, processes, and/or devices of the system 100, processing resource 202, feature extractor 420, inferencing platform 500, cand/or other above or below mentioned systems or devices, or parts of such circuits, circuitry, functionality, systems, apparatuses, processes, or devices.

By way of example, the system 700 may comprise one or more processor 702 (sometimes referred to as control circuits) as processing resource, one or more memory 704, and one or more communication links 706, paths, buses or the like. Some embodiments may include one or more user interfaces 708, and/or one or more internal and/or external power sources or supplies 710. The processor 702 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor 702 can be part of control circuitry and/or a control circuit 712, which may be implemented through one or more processors with access to one or more memory 704 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 700 may be used to implement one or more of the above or below, or parts of, components, circuits, systems, processes and the like.

The user interface 708 can allow a user to interact with the system 700 and receive information through the system. In some instances, the user interface 708 includes a display 714 and/or one or more user inputs 716, such as buttons, touch screen, track ball, keyboard, mouse, etc., which can be part of or wired or wirelessly coupled with the system 700. Typically, the system 700 further includes one or more communication interfaces, ports, transceivers 718 and the like allowing the system 700 to communicate over a communication bus, a distributed computer and/or communication network 101 (e.g., a local area network (LAN), the Internet, wide area network (WAN), etc.), communication link 706, other networks or communication channels with other devices and/or other such communications or combination of two or more of such communication methods. Further the transceiver 718 can be configured for wired, wireless, optical, fiber optical cable, satellite, or other such communication configurations or combinations of two or more of such communications. Some embodiments include one or more input/output (I/O) ports 720 that allow one or more devices to couple with the system 700. The I/O ports 720 can be substantially any relevant port or combinations of ports, such as but not limited to USB, Ethernet, or other such ports. The I/O ports 720 or interfaces can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

The system 700 comprises an example of a control and/or processor-based system with the control circuit 712. Again, the control circuit 712 can be implemented through one or more processors, controllers, central processing units, logic, software and the like. Further, in some implementations the control circuit 712 may provide multiprocessor functionality. While FIG. 7 illustrates the various components being coupled together via a bus, it is understood that the various components may actually be coupled to the control circuit and/or one or more other components directly.

In some embodiments, a system comprises a processing resource and a machine readable medium. The machine readable medium stores instructions that, when executed, causes the processing resource to: aggregate, during an interaction session, session data based on client interactions in a client interface provided to a client device, update, periodically and during the interaction session, one or more inference indicators associated with the client in an inference cache storage, the one or more inference indicators being determined via a trained machine learning model using the session data and historical data in a historical data database, identify a trigger event based on client interactions in the client interface during the interaction session and subsequent to the one or more inference indicators being updated, retrieve, in response to the trigger event, at least one inference indicator associated with the client from the inference cache storage, and generate a personalized content for display on the client device based on the at least one inference indicator retrieved from the inference cache storage.

In some aspects, the one or more inference indicators are updated by identifying session features based on the session data and identifying historical features based on the historical data. The session features and historical features are used as an input of the machine learning model to determine the one or more inference indicators.

In some aspects, the session features and the historical features are identified and extracted based on a set of registered features.

In some aspects, the historical data database stores item view history, purchase history, search history, and/or cart history from one or more prior interaction sessions.

In some aspects, the session data includes items viewed, items added to a virtual cart, quantities of items in the virtual cart, item prices, item fulfillment types, search queries, an average time between actions, and/or an average time between changes in the virtual cart.

In some aspects, the machine readable medium stores instructions that, when executed, causes the processing resource to record subsequent interactions with the personalized content as part of the session data and retrain the machine learning model using the session data, including the subsequent interactions.

In some forms, the subsequent interaction includes an item view, a change in a virtual cart, a search query, a fulfillment type selection, and/or a checkout.

In some aspects, the one or more inference indicators are periodically redetermined by the processing resource every 1 to 10 minutes, while the interaction session is active.

In some aspects, the instructions when executed by the processing resource, cause the processing resource to further: determine whether to further update the at least one inference indicator based on a confidence score associated the at least one inference indicator subsequently determined via the trained machine learning model.

In some aspects, the one or more inference indicators include an inference indicator that corresponds to a cross-category purchase probability.

In some aspects, the one or more inference indicators include an inference indicator that corresponds to a likelihood of a fulfillment method, the fulfillment method being one of in-store pickup, delivery, or shipping.

In some aspects, the one or more inference indicators include an inference indicator that corresponds to a measure of a user commitment to purchase, a shopping session completeness, or a user exploration interest.

In some aspects, the personalized content comprises one or more items and/or one or more promotions selected for display based on the inference indicator.

In some aspects, the personalized content comprises a client interface layout selected based on the inference indicator.

In some aspects, the trained machine learning model includes a feedforward neural network model, a logistic regression model, and/or a multi-layer perceptron model.

In some aspects, the machine readable medium stores instructions that, when executed, causes the processing resource identify a second trigger event based on actions in the client interface displaying the personalized content, retrieve, in response to the second trigger event, the at least one inference indicator from the inference cache storage, and generate a second personalized content for display in the client interface based on the at least one inference indicator retrieved from the inference cache storage.

In some embodiments, a non-transitory machine readable medium stores instructions that, when executed, cause a processing resource to perform various actions or functions. During an interaction session, the instructions aggregate session data based on client interactions in a client interface provided to a client device. The instructions update, periodically and during the interaction session, one or more inference indicators associated with the client in a inference cache storage, the one or more inference indicators being determined via a trained machine learning model using the session data and historical data in a historical data database. The instructions further identify a trigger event based on client interactions in the client interface during the interaction session and subsequent to the one or more inference indicators being updated. The instructions retrieve, in response to the trigger event, at least one inference indicator associated with the client from the inference cache storage. Subsequently, personalized content for display on the client device is generated by the instructions based on the at least one inference indicator retrieved from the inference cache storage.

In some embodiments, a method for generating personalized content is described. The method includes aggregating, with a processing resource and during an interaction session, session data based on client interactions in a client interface provided to a client device, updating, with the processing resource, periodically, and during the interaction session, one or more inference indicators associated with the client in a inference cache storage, the one or more inference indicators being determined via a trained machine learning model using the session data and historical data in a historical data database, identifying, with the processing resource, a trigger event based on client interactions in the client interface during the interaction session and subsequent to the one or more inference indicators being updated, retrieving, with the processing resource and in response to the trigger event, at least one inference indicator associated with the client from the inference cache storage, and generating, with the processing resource, a personalized content for display on the client device based on the at least one inference indicator retrieved from the inference cache storage.

In some aspects, the one or more inference indicators are updated by identifying session features based on the session data, identifying historical features based on the historical data; and determining the one or more inference indicators using the session features and the historical features as input of the machine learning model.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system comprising:
a processing resource; and
a machine readable medium storing instructions that, when executed, cause the processing resource to:
aggregate, during an interaction session, session data based on client interactions in a client interface provided to a client device;
update, periodically and during the interaction session, one or more inference indicators associated with the client in an inference cache storage, the one or more inference indicators being determined via a trained machine learning model using the session data and historical data in a historical data database;
identify a trigger event based on client interactions in the client interface during the interaction session and subsequent to the one or more inference indicators being updated;
retrieve, in response to the trigger event, at least one inference indicator associated with the client from the inference cache storage; and
generate a personalized content for display on the client device based on the at least one inference indicator retrieved from the inference cache storage.

2. The system of claim 1, wherein the one or more inference indicators are updated by:
identifying session features based on the session data;
identifying historical features based on the historical data; and
determine the one or more inference indicators using the session features and the historical features as input of the machine learning model.

3. The system of claim 2, wherein the session features and the historical features are identified and extracted based on a set of registered features.

4. The system of claim 1, wherein the historical data database stores item view history, purchase history, search history, and/or cart history from one or more prior interaction sessions.

5. The system of claim 1, wherein the session data comprises items viewed, items added to a virtual cart, quantities of items in the virtual cart, item prices, item fulfillment types, search queries, an average time between actions, and/or an average time between changes in the virtual cart.

6. The system of claim 1, where the instructions when executed by the processing resource, cause the processing resource to further:
record subsequent interactions with the personalized content as part of the session data; and
retrain the trained machine learning model using the session data, including the subsequent interactions.

7. The system of claim 6, wherein the subsequent interaction includes an item view, a change in a virtual cart, a search query, a fulfillment type selection, and/or a checkout.

8. The system of claim 1, wherein the one or more inference indicators are periodically redetermined by the processing resource every 1 to 10 minutes, while the interaction session is active.

9. The system of claim 1, wherein the instructions when executed by the processing resource, cause the processing resource to further: determine whether to further update the at least one inference indicator based on a confidence score associated the at least one inference indicator subsequently determined via the trained machine learning model.

10. The system of claim 1, wherein the one or more inference indicators include an inference indicator that corresponds to a cross-category purchase probability.

11. The system of claim 1, where the one or more inference indicators include an inference indicator that corresponds to a likelihood of a fulfillment method, the fulfillment method being one of in-store pickup, delivery, or shipping.

12. The system of claim 1, wherein the one or more inference indicators include an inference indicator that corresponds to a measure of a user commitment to purchase, a shopping session completeness, or a user exploration interest.

13. The system of claim 1, wherein the personalized content comprises one or more items and/or one or more promotions selected for display based on the inference indicator.

14. The system of claim 1, wherein the personalized content comprises a client interface layout selected based on the inference indicator.

15. The system of claim 1, wherein the trained machine learning model includes a feedforward neural network model, a logistic regression model, and/or a multi-layer perceptron model.

16. The system of claim 1, wherein the instructions when executed by the processing resource, cause the processing resource to further:
identify a second trigger event based on actions in the client interface displaying the personalized content;
retrieve, in response to the second trigger event, the at least one inference indicator from the inference cache storage; and
generate a second personalized content for display in the client interface based on the at least one inference indicator retrieved from the inference cache storage.

17. A non-transitory machine readable medium storing instructions that, when executed, cause a processing resource to:
aggregate, during an interaction session, session data based on client interactions in a client interface provided to a client device;
update, periodically and during the interaction session, one or more inference indicators associated with the client in a inference cache storage, the one or more inference indicators being determined via a trained machine learning model using the session data and historical data in a historical data database;
identify a trigger event based on client interactions in the client interface during the interaction session and subsequent to the one or more inference indicators being updated;
retrieve, in response to the trigger event, at least one inference indicator associated with the client from the inference cache storage; and
generate a personalized content for display on the client device based on the at least one inference indicator retrieved from the inference cache storage.

18. The non-transitory machine readable medium of claim 17, wherein the one or more inference indicators are updated by:
identifying session features based on the session data;
identifying historical features based on the historical data; and
determine the one or more inference indicators using the session features and the historical features as input of the machine learning model.

19. A method comprising:
aggregating, with a processing resource and during an interaction session, session data based on client interactions in a client interface provided to a client device;
updating, with the processing resource, periodically, and during the interaction session, one or more inference indicators associated with the client in a inference cache storage, the one or more inference indicators being determined via a trained machine learning model using the session data and historical data in a historical data database;
identifying, with the processing resource, a trigger event based on client interactions in the client interface during the interaction session and subsequent to the one or more inference indicators being updated;
retrieving, with the processing resource and in response to the trigger event, at least one inference indicator associated with the client from the inference cache storage; and
generating, with the processing resource, a personalized content for display on the client device based on the at least one inference indicator retrieved from the inference cache storage.

20. The method of claim 19, wherein the one or more inference indicators are updated by:
identifying session features based on the session data;
identifying historical features based on the historical data; and
determine the one or more inference indicators using the session features and the historical features as input of the machine learning model.
